(19) United States
(12) Patent Application Publication
(10) Pub. No.: US 2004/0267771 A1
(43) Pub. Date: Dec. 30, 2004

(54) Method, system and computer program product for providing business logic transaction processing

(75) Inventor: Scott R. Crowther, New Paltz, NY (US)

Correspondence Address: John E. Campbell, IBM Corporation, 2455 South Road, P386, Poughkeepsie, NY, 12601, US

(73) Assignee: International Business Machines Corporation, Armonk, NY

(21) Appl. No.: 10/609,793

(22) Filed: Jun. 30, 2003

(51) Int. Cl. G06F 7/00

(52) U.S. Cl. 707/100

(57) ABSTRACT

A method for providing business logic transaction processing is disclosed. The method comprises receiving a transaction XML document from a requester via a calling program. The transaction type is extracted from the transaction XML document and a business implementation component responsive to the transaction type is determined. A command to instantiate the business implementation component is transmitted. The method further comprises transmitting the transaction XML document to the business implementation component, where the business implementation component extracts a transaction input parameter from the XML document. A response XML document is received from the business implementation component. The response XML document is responsive to the transaction input parameter and to the transaction XML document. The response XML document is transmitted to the requester via the calling program.

### BACKGROUND OF THE INVENTION

The present disclosure relates generally to a method for providing business logic transaction processing, and more particularly to a method for providing a single proxy interface between the presentation interface and business logic computer modules.

Extensible Markup Language (XML) is utilized by application programmers to define standard ways of managing and exchanging complex documents. XML is a universal syntax for describing and structuring data independent from the application logic. New XML tags and XML document structures may be defined along with metadata that lets programs discover “on the fly” a new structure and understand the new tags. An XML document typically contains one or more elements bracketed by start and end tags. Elements include tag names, content (may be empty) and attributes (each attribute has a name and value). An XML document may also be utilized to represent containment modules.

The Document Object Model (DOM) is a platform and language neutral interface that allows programs and scripts to dynamically access and update the content, structure and style of XML documents. The document can be further processed and the results of the processing can be incorporated back in the presented page. The DOM defines interfaces that allow a programmer to control every tag and structure within an XML document. On the client side, a browser parses an XML document and then generates a tree representation in memory. The application program then uses DOM invocations to navigate the tree and manipulate different elements within the document. On the server side the document is typically parsed by an application server. The DOM allows clients and server programs to generate and interchange data and manipulate the results.

A component is an object that is not bound by a particular program, computer language or implementation. Components are thought to be the optimal building blocks for creating distributed systems. The use of components may reduce application complexity, development cost and development time. In addition, components may improve software reusability, maintainability and platform independence. Components interact using language neutral client/server interaction models. Unlike traditional objects, components can interoperate across languages, tools, operating systems and networks.

An increasing number of business application programs are becoming network accessible. In many cases, the functions of purchased application modules, legacy system application modules and newly developed application modules are combined and presented to an end user via a single network accessible user interface. Typically, the name, input parameters and output parameters are “hard coded” into the user interface code to define the corresponding module or component. “Hard coding” specific code module information into user interface code may make it costly to make updates.

### SUMMARY OF THE INVENTION

In one embodiment, a method for providing business logic transaction processing is disclosed. The method comprises receiving a transaction XML document from a requester via a calling program. The transaction type is extracted from the transaction XML document and a business implementation component responsive to the transaction type is determined. A command to instantiate the business implementation component is transmitted. The method further comprises transmitting the transaction XML document to the business implementation component, where the business implementation component extracts a transaction input parameter from the XML document. A response XML document is received from the business implementation component. The response XML document is responsive to the transaction input parameter and to the transaction XML document. The response XML document is transmitted to the requester via the calling program.

In another embodiment, a method for providing business logic transaction processing is disclosed. The method comprises receiving a transaction XML DOM object from a requester via a calling program. The transaction XML DOM object is parsed. The parsing includes extracting a transaction type from the transaction XML DOM object and determining a business implementation component responsive to the transaction type. A command to instantiate the business implementation component is transmitted. The transaction XML DOM object is transmitted to the business implementation component, where the business implementation component extracts a transaction input parameter from the XML DOM object. A response XML DOM object is received from the business implementation component. The response XML DOM object is responsive to the transaction input parameter and to the transaction XML DOM object. The response XML DOM object is transmitted to the requester via the calling program.

In another embodiment, a computer program product for providing business logic transaction processing is disclosed. The computer program product comprises a storage medium readable by a processing circuit and storing instructions for execution by the processing circuit for performing a method. The method comprises a method for providing business logic transaction processing is disclosed. The method comprises receiving a transaction XML document from a requester via a calling program. The transaction type is extracted from the transaction XML document and a business implementation component responsive to the transaction type is determined. A command to instantiate the business implementation component is transmitted. The method further comprises transmitting the transaction XML document to the business implementation component, where the business implementation component extracts a transaction input parameter from the XML document. A response XML document is received from the business implementation component. The response XML document is responsive to the transaction input parameter and to the transaction XML document. The response XML document is transmitted to the requester via the calling program.

In a further embodiment, a system for providing business logic transaction processing is disclosed. The system comprises a network and a user system in communication with the network. The system also comprises a host system in communication with the network, where the host system includes instructions to execute a method comprising receiving a transaction XML document from a requester on the user system, via a calling program and the network. A transaction type is extracted from the transaction XML document and a business implementation component responsive to the transaction type is determined. A command to instantiate the business implementation component is transmitted via the network. The transaction XML document is transmitted via the network to the business implementation component, where the business implementation component extracts a transaction input parameter from the transaction XML document. A response XML document is received from the business implementation component via the network. The response XML document is responsive to the transaction input parameter and to the transaction XML document. The response XML document is transmitted to the requester via the calling program and the network.

### BRIEF DESCRIPTION OF THE DRAWINGS

Referring to the exemplary drawings wherein like elements are numbered alike in the accompanying Figures:

FIG. 1 is a block diagram of an exemplary system for providing business logic transaction processing;

FIG. 2 is a block diagram of the components of a business logic transaction processing system in accordance with an exemplary embodiment of the present invention; and

FIG. 3 is an exemplary process flow for performing business logic transaction processing.

### DETAILED DESCRIPTION OF THE INVENTION

An exemplary embodiment of the present invention utilizes a state design pattern in a network-based business logic transaction processing application to dynamically switch implementations of the underlying business logic. XML transactions passed into a proxy class (derived from a base interface class) from the user interface (UI) level are interrogated for the transaction type (described in the transaction XML), and then the proxy class changes an internal instance handle to a specific implementation of that same base interface. The XML transaction is then passed by the proxy to the type-specific implementation and specialized business logic executes against the transaction. Results are then returned as an XML document to the proxy, which is then returned to the invoking network-based front end in an XML response document. The business logic transaction processing application is driven by calling logic from the UI and not by events.

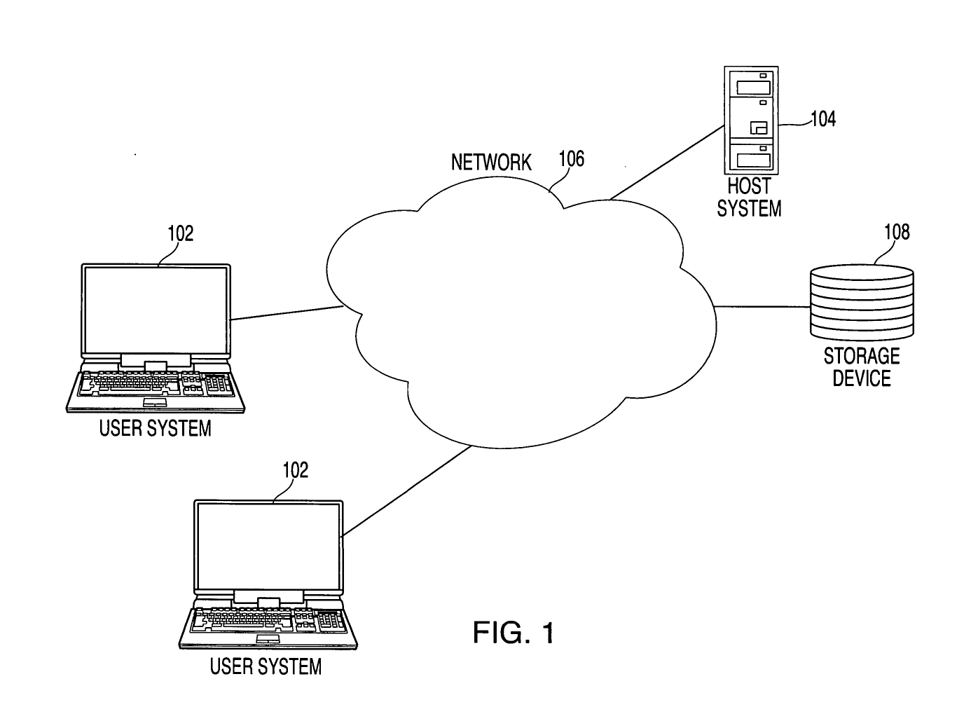

In FIG. 1 a block diagram of an exemplary system for providing business logic transaction processing is generally shown. The system includes one or more user systems 102 through which users at one or more geographic locations may contact the host system 104 to initiate the execution of the business logic transaction processing. In an exemplary embodiment, the host system 104 executes the business logic transaction processing and the user system 102 is coupled to the host system 104 via a network 106. Each user system 102 may be implemented using a general-purpose computer executing a computer program for carrying out the processes described herein. The user system 102 may be a personal computer (e.g., a lap top, a personal digital assistant) or a host attached terminal. If the user system 102 is a personal computer, the business logic processing described herein may be shared by a user system 102 and the host system 104 (e.g., by providing an applet to the user system 102).

The network 106 may be any type of known network including, but not limited to, a wide area network (WAN), a local area network (LAN), a global network (e.g., Internet), a virtual private network (VPN) and an intranet. The network 106 may be implemented using a wireless network or any kind of physical network known in the art. A user system 102 may be coupled to the host system through multiple networks (e.g., intranet and Internet) so that not all user system 102 are coupled to the host system 104 through the same network. One or more of the user systems 102 and the host system 104 may be connected to the network 106 in a wireless fashion.

The storage device 108 may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. The physical data may be located in a variety of geographic locations depending on application and access requirements. Information stored in the storage device 108 may be retrieved and manipulated via the host system 104. The storage device 108 includes application data such as the rules for routing transactions. The storage device 108 may also include other kinds of data such as information concerning the transactions (e.g., a user identifier, date and time of creation). In an exemplary embodiment, the host system 104 operates as a database server and coordinates access to application data including data stored on storage device 108.

The host system 104 depicted in FIG. 1 may be implemented using one or more servers operating in response to a computer program stored in a storage medium accessible by the server. The host system 104 may operate as a network server (e.g., a web server) to communicate with the user system 102. The host system 104 handles sending and receiving information to and from the user system 102 and can perform associated tasks. The host system may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs to perform business logic transaction processing functions. Business logic transaction processing functions are described in more detail herein and may include receiving an XML document for processing and invoking business implementation components associated with the XML document. Processing of the business implementation components may be shared by the user system 102 and the host system 104 by providing an application (e.g., a java applet) to the user system 102. Functions performed by the business implementation components may be executed on one or more remote host systems using data from one or more remote data sources. Alternatively, the user system 102 can include a stand-alone software application for performing a portion or all of the processing described herein. In an exemplary embodiment, the business logic component is located in the host system 104 and is not distributed to the user systems 102. As previously described, it is understood that separate servers may be utilized to implement the network server functions and the application server functions. Alternatively, the network server, the firewall, and the application server may be implemented by a single server executing computer programs to perform the requisite functions.

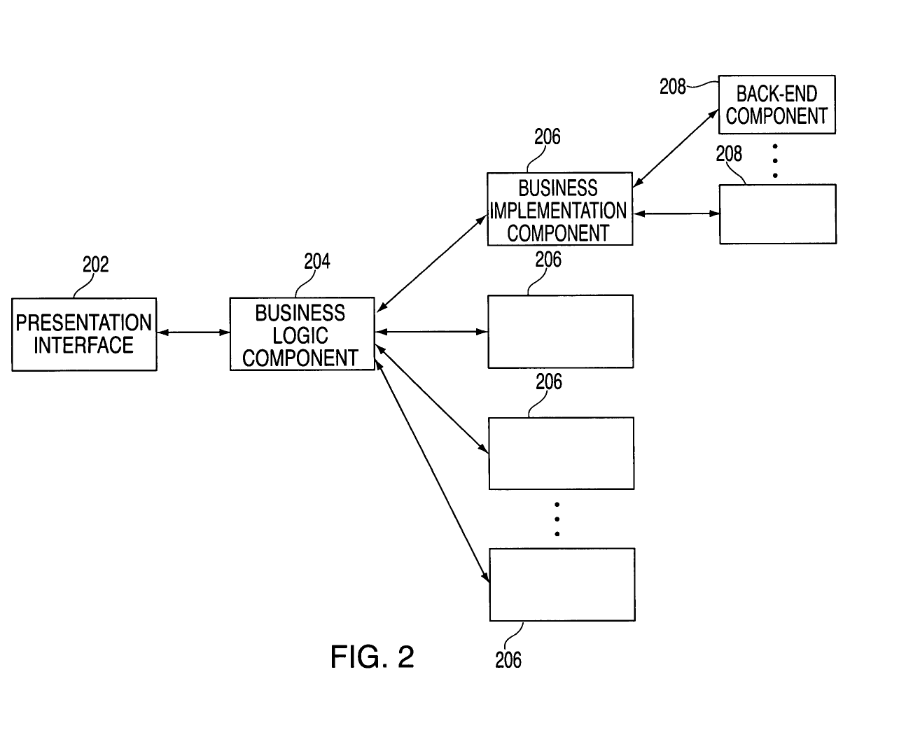

FIG. 2 is a block diagram of the components of a business logic transaction processing system in accordance with an exemplary embodiment of the present invention. The components include a presentation interface 202, a business logic component 204 and one or more business implementation components 206. In addition, the components of the business logic transaction processing system may include one or more back-end components 208 invoked by the business implementation components 206. In an exemplary embodiment of the present invention, the business logic component 204 serves as a single conduit between the presentation interface 202 and the business implementation components 206. The business logic component 204 receives transactions from the presentation interface 202 and directs the appropriate business implementation component 206 to begin execution. Likewise, information received by the business logic component 204 from the business implementation components 206 will be directed back to the presentation interface 202 located on a user system 102. The business logic component 204 may be conceptualized as the driver program for the business logic transaction processing system, directing messages between the business implementation components 206 and serving as an interpreter between these business implementation components 206 and the front end presentation interface 202. In an exemplary embodiment of the present invention, the business logic component 204 serves as a “proxy” between the graphical user interface (GUI) front end and the business implementation components 206. This may result in insulating the business implementation components 206 from direct access by outside user systems 102.

In an exemplary embodiment of the present invention, the business implementation components 206 are developed as “black boxes” where internal logic regarding the use of other business implementation components 206 and tools remains internal to each business implementation component 206. The business implementation components 206 validate input parameters, process the transaction received from the business logic component 204 and send back an XML document as a response. Examples of business implementation components 206 for a purchasing application may include an insert purchase order component, a delete purchase order component and a modify purchase order component. The business implementation components 206 may interact with (e.g., instantiate, execute) target back-end components 208 and/or other business implementation components 206. In this manner, a business implementation component 206 may instantiate another object. Therefore, the business implementation component 206 may send any required input parameters to an object and receive back from the object any output parameters.

As depicted in FIG. 2, information is transferred from the presentation interface 202 to the business logic component 204 in XML format. In an exemplary embodiment of the present invention, the business logic component 204 is a transaction driven system where transactions are spawned from a user system 102 via the presentation interface 202 and from the business implementation component 206 back-end. In an exemplary embodiment of the present invention, the presentation interface 202 component will be the only component utilizing the business logic component 204 directly. The utilization of the business logic component 204 by the presentation interface 202 will involve a method call such as: processTransaction( ). This method accepts a transaction XML DOM object as an argument and returns a response XML DOM object to the presentation interface 202. The calling code of the presentation interface 202 will be required to catch a single exception, in the event that the response building code fails. In all other situations, including a failed transaction, any error code may be added to the response object return type.

The presentation interface 202 calling code sent to the business logic component 204 is in the form of an XML document. The XML document includes the transaction type and transaction input parameters. In an exemplary embodiment of the present invention, the presentation interface 202 instantiates the business logic component 204 when it sends the XML document to the business logic component 204. Also, as depicted in FIG. 2, the presentation interface 202 receives data from the business logic component 204. The presentation interface 202 receives a response XML document from the business logic component 204 once the transaction has been completed. The same XML response document is passed from the business implementation component 206 to the business logic component 204 and then on to the presentation interface 202.

In an exemplary embodiment of the present invention, the business logic component 204 is designed and implemented using a “state” design pattern, where the term “state” refers to the transaction being processed. From a base business logic component 204 interface, a surrogate class is derived along with multiple classes that provide actual implementations to handle each transaction type received from the presentation interface 202. The presentation interface 202 converses with the surrogate derivation, while this surrogate class modifies the particular implementation it proxies for each transaction type encountered. With this state pattern, the business logic component 204 logic will be given a transaction specific implementation that will essentially become a mapping of that transaction type to a set of derivable rules that the business logic component 204 will drive. The rule set is not hard-coded, in contrast it is dynamic in nature. The rule set may be updated (e.g., new components added, components changed, components removed) without impact to the existing system. In an exemplary embodiment of the present invention, the name of the business implementation component 206 associated with a transaction name is the transaction name with the string “LOGIC” appended to the end.

The level of complexity of maintaining a one case-driven method to handle all types of transactions is broken up in this pattern by separating the elements that change from the elements that stay the same. In an exemplary embodiment of the present invention, the surrogate business logic component 204 will be fronting the implementation to specific transaction logic, by providing a single interface for the presentation interface 202 to utilize. This maintains the elements that stay the same, such as processing a transaction, retrieving the last transaction processed and retrieving the last response delivered. By adding different implementations to the business logic component 204, the elements that change are separated where different logic for different transactions are simplified by keeping them separated. This design positions the business logic component 204 to drive actions to other business implementation components 206, and business implementation component 206 specific solutions without adding complexity to the business logic component 204 code. When working with one type of transaction, it is not necessary to know how other transactions are handled and the business rules are dictated by the implementation currently being utilized. Error handling and messages will be recorded and resolved, if possible by the business implementation components 206.

In an exemplary embodiment of the present invention, the steps taken by the business logic component 204 upon receiving a transaction XML DOM object include: extracting the transaction type from the XML DOM; initiating the execution of the business implementation component 206 associated with the transaction type; and receiving a response in the form of an XML DOM object from the business implementation component 206; and sending the response to the presentation interface 202. The transaction type is determined from extracting the XML transaction type attribute (e.g., a mapping representation from a getTransactionType( ) method). Based on the extracted transaction type (e.g., extracted by getTransactionType( )), the surrogate will change the implementation handle reference to the appropriate business implementation component 206 implementation. Once this is performed, the surrogate will once again call the processTransaction( ) function for the new implementation. This in effect causes a determination of rule sets (e.g., by a rule set algorithm), where a transaction is mapped to a specific implementation, which is in turn mapped to the corresponding business implementation components 206 to carry out the transaction. Sample transaction types and associated data stored in the storage device 108 and accessed by the business logic component 204 are listed below. A small subset of transaction types are shown below, an actual implementation may have any number of transaction types. The component object interaction is the list of back-end components 208 invoked by the business implementation component 206. The transaction parameters extracted is the list of parameters that are input to the business implementation component 206 and the component object returned is the list of parameters that are output by the business implementation component 206.

Transaction Type: Logon

Business implementation component: LogonLogic

Component Object Interaction: Profadministrator's UserAccount

Transaction Parameters Extracted: USERID, PASSWORD

Component Object Returned: Response XML with system success return code

Transaction Type: GetUserProfile

Business implementation component: GetUserProfileLogic

Component Object Interaction: Profadministrator's UserAccount

Transaction Parameters Extracted: USERID

Component Object Returned: User Profile XML Response

Transaction Type: InsertPurchaseOrder

Business implementation component: InsertPurhcaseOrderLogic

Component Object Interaction: Profadmin UserAcct;Order Svcs Sales Order

Transaction Parameters Extracted: USERID, Purchase Order

Component Object Returned: Simple system success completion response

An exemplary class definition for the BusinessLogic class implemented by the business logic component 204 includes:

BusinessLogic

Class Description: BusinessLogic is the driver class that drives/directs/routes transactions from the presentation interface 202 to the corresponding business implementation components 206. The BusinessLogic class will be instantiated by presentation services and utilizes a flexible/derivable rule set to apply to an incoming transaction.

BusinessLogic( )

Method Description: Constructor method

Method Signature: BusinessLogic b=new

BusinessLogic( )

ProcessTransaction( )

Method Description: Transaction processing method which accepts a transaction DOM XML object, initiates the appropriate component response, and returns a Response DOM XML object. Method Signature—public Response ProcessTransaction (TransactionobjTransaction);

GetTransactionType( )

Method Description: private method which returns a string representation of the transaction type of the intercepted transaction object. Method Signature: private string

getTransactionType(TransactionobjTransac tion);

RetrieveLastResponse( )

Method Description: returns the last response XML DOM object produced by BusinessLogic. The reasoning behind providing such a method is to allow the presentation services to retrieve the last response for handling error/exception/logging/auditing conditions.

Method Signature: public response retreiveLastResponse( );

RetrieveLastTransaction( )

Method Description: returns the last transaction XML DOM object received by Business Logic. The reasoning behind providing such a method is to allow presentation services to retrieve the last transaction for handling error/exception/logging/auditing conditions.

Method Signature: public response RetrieveLastTransaction (TransactionobjTransaction).

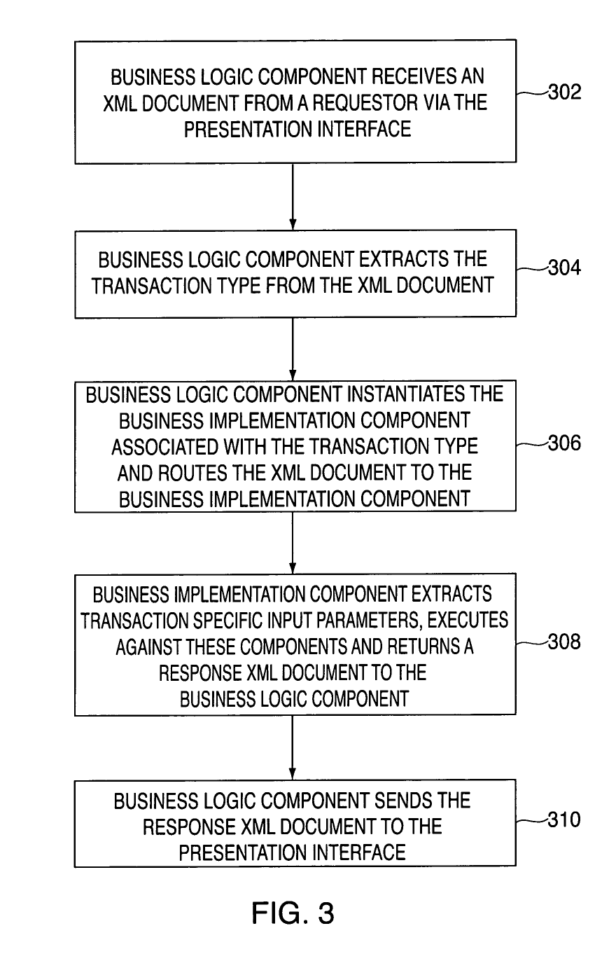

FIG. 3 is an exemplary process flow for performing business logic transaction processing as described above. At step 302, the business logic component 204 receives an XML document from a requester at a user system 102 via the presentation interface 202. The business logic component 204 extracts the transaction type from the XML document at step 304. At step 306, the business logic component 204 instantiates the business implementation component 206 associated with the transaction type. To perform the instantiation, the business logic component 204 may send an instantiate command, including the transaction XML document, to the business implementation component 206. At step 308, the business implementation component 206 extracts transaction specific parameters from the XML document and executes against these parameters. In addition, the business implementation component 206 returns a response XML document to the business logic component 204 at step 308. The response XML document is responsive to the transaction XML document and to the transaction specific parameters. Finally, at step 310, the business logic component 204 sends the response XML document received from the business implementation component 206, to the user system 102 via the presentation interface 202.

An exemplary embodiment of the present invention separates the logic that changes from the logic that remains the same in a business logic implementation. The business logic transaction processing system provides a standard interface with which a presentation interface 202 front end may issue a transaction. At the same time, underlying business logic for the specific transaction may change without impacting the presentation interface. As new releases of the system implementing the business logic are defined, adding additional transactions to the system does not interfere with previously existing transactions. Business logic implementations therefore, are decoupled from each other, making for ease of maintenance and system expandability. Any number of transactions may be supported by the system and added, delete and/or modified without impacting the existing transactions.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for providing business logic transaction processing, the method comprising:
receiving a transaction XML document from a requester via a calling program; extracting a transaction type from said transaction XML document;
determining a business implementation component responsive to said transaction type;
transmitting a command to instantiate said business implementation component;
transmitting said transaction XML document to said business implementation component, wherein said business implementation component extracts a transaction input parameter from said transaction XML document;
receiving a response XML document from said business implementation component responsive to said transaction input parameter and to said transaction XML document; and
transmitting said response XML document to the requester via the calling program.

2. The method of claim 1 wherein said business implementation component transmits a command to execute any one of a back-end component or a second business implementation component.

3. The method of claim 1 wherein said determining is performed by a rule set algorithm.

4. The method of claim 3 further comprising updating said rule set algorithm, wherein said calling program remains unchanged.

5. The method of claim 4 wherein said updating includes any one of adding a new transaction type, associating a different business implementation component with said transaction type or updating includes removing a business implementation component.

6. The method of claim 1 wherein said calling program is any one of a business application program, web based, a presentation interface or a personal digital assistant.

7. The method of claim 1 wherein said business implementation component performs any one of a business process or an administrative process.

8. The method of claim 1 wherein said determining includes adding a string to the end of said transaction type.

9. The method of claim 15 wherein said string includes “LOGIC”.

10. The method of claim 1 wherein said business logic component is implemented using a business logic class, wherein said class includes a business logic method, a process transaction method, a get transaction type method, a retrieve last response method and a retrieve last transaction method.

11. The method of claim 1 wherein said XML document comprises an XML DOM document.

12. A computer program product for providing business logic transaction processing, the computer program product comprising:
a storage medium readable by a processing circuit and storing instructions for execution by the processing circuit for performing a method comprising:
receiving a transaction XML document from a requester via a calling program;
extracting a transaction type from said transaction XML document;
determining a business implementation component responsive to said transaction type;
transmitting a command to instantiate said business implementation component;
transmitting said transaction XML document to said business implementation component, wherein said business implementation component extracts a transaction input parameter from said transaction XML document;
receiving a response XML document from said business implementation component responsive to said transaction input parameter and to said transaction XML document; and
transmitting said response XML document to the requester via the calling program.

13. The computer program product of claim 12 wherein said business implementation component transmits a command to execute any one of a back-end component or a second business implementation component.

14. The computer program product of claim 12 wherein said calling program is any one of a business application program, web based, a presentation interface or a personal digital assistant.

15. The computer program product of claim 12 wherein said business logic component is implemented using a business logic class, wherein said class includes a business logic method, a process transaction method, a get transaction type method, a retrieve last response method and a retrieve last transaction method.

16. The computer program product of claim 12 wherein said XML document comprises an XML DOM document.

17. A system for providing business logic transaction processing, the system comprising:
a network;
a user system in communication with the network;
a host system in communication with the network, wherein said host system includes instructions to execute a method comprising:
receiving a transaction XML document from a requester on said user system via a calling program and the network;
extracting a transaction type from said transaction XML document;
determining a business implementation component responsive to said transaction type;
transmitting a command via the network to instantiate said business implementation component;
transmitting said transaction XML document via the network to said business implementation component, wherein said business implementation component extracts a transaction input parameter from said transaction XML document;
receiving a response XML document from said business implementation component via the network responsive to said transaction input parameter and to said transaction XML document; and
transmitting said response XML document to the requester via the calling program and the network.

18. The system of claim 17 wherein said network is any one of the Internet or an intranet.

19. The system of claim 17 wherein said business implementation component is located on said host system.

20. The system of claim 17 further comprising a remote host system in communication with said network, wherein said business implementation component is located on said remote host system.
